(19) United States
(12) Patent Application Publication
(10) Pub. No.: US 2005/0050548 A1
(43) Pub. Date: Mar. 3, 2005

(54) Application internationalization using dynamic proxies

(75) Inventors: Joseph Sheinis, Ontario (CA); Michael Baldwin, Ontario (CA); Alexander Sherkin, Ontario (CA)

Correspondence Address: MEYERTONS, HOOD, KIVLIN, KOWERT & GOETZEL, P.C., P.O. BOX 398, AUSTIN, TX, 78767-0398, US

(73) Assignee: Sun Microsystems, Inc., Santa Clara, CA (US)

(21) Appl. No.: 10/650,880

(22) Filed: Aug. 28, 2003

(51) Int. Cl. G06F 9/00

(52) U.S. Cl. 719/311

(57) ABSTRACT

An application that was not internationalized when coded may be internationalized through the addition of interception and localization logic and tables without modification of the original application logic. The interception logic may be configured to intercept calls to an application component and invoke localization logic in response to an intercepted call to the application component. The interception logic may use dynamic proxies to intercept method calls from a client component to an application component both before and after the execution of the method. The interception logic may use JAVA reflection to determine whether input parameters or return values associated with the method call are localizable. The application component logic may operate on data stored in a primary database table in which the data is represented in the system default locale.

### BACKGROUND

1. Field of the Invention

This invention relates to computer systems, and more particularly to interception of calls to a component of an application in order to provide localization/internationalization services for the application component.

2. Description of the Related Art

A major concern for global enterprise applications may be internationalization/localization. Enterprises are going global. Even small, family-owned companies are finding new customer bases and supply-chain partners in parts of the world that they would not previously have considered. The Internet provides the communications backbone for increasing global interconnectedness.

Global operation requires information systems to address a fundamental linguistic, cultural, political, financial, and geographic requirements. Users of a global application may speak any of dozens of languages. Applications targeted at only a single country often require multiple language interfaces and units of measure often do not correspond exactly to a language. Cultural differences may cause a product or service that is highly sought-after in one region to be offensive in another. Some governments place limitations on ideas, images, and/or speech. Currencies and forms of payment may differ from region to region and governments have various requirements for customs restrictions, tariffs and taxes. Product pricing, shipping mode, and delivery time may also vary by both supply and delivery location. These are just a few of the issues that arise when doing business in a global environment.

Various obstacles relating to these concerns may be encountered during implementation of an enterprise application. For example, although application container or server products typically provide common concern-specific logic for use by applications, some concern-specific logic may not be supported or may be supported in a limited manner. Concern-specific logic for common services such as security may be delegated to containers and/or servers in which the application components execute.

An example of concern-specific logic, which may not be supplied by containers is localization logic. Localization may be the customization of data presentation of the set of political, cultural, and region-specific elements represented in an application. Each unique representation of the set of such elements may be referred to as a locale. For example, some of the elements included in such a localization set may be language, numerical representation, and units of measure such as date, time, temperature, currency, etc. An application that is not internationalized may have all information stored in one locale, which may be referred to as the system default locale. In order to internationalize such an application, localization logic is typically implemented by adding additional logic for localization into each application component.

Modifying deployed application logic to add localization functionality may have a large, negative impact on the availability of the application and thus the bottom line of the business in which it is employed. Any time application component logic is altered the opportunity exists for introducing bugs not only into the code for the additional functionality, but also into the existing functions that have already undergone extensive verification prior to deployment. The internationalized version of the application then becomes an entirely new and more complex application that may need to be completely re-verified. Several iterations of deployment and testing may be required before the internationalized application achieves the same level of reliability as its predecessor.

### SUMMARY

An application that was not internationalized when coded may be internationalized through the addition of interception and localization logic and tables without modification of the original application logic. The interception logic may be configured to intercept calls to an application component and invoke localization logic in response to an intercepted call to the application component. The interception logic may use dynamic proxies to intercept method calls from a client component to an application component both before and after the execution of the method. The interception logic may use Java reflection to determine whether input parameters or return values associated with the method call are localizable. The application component logic may operate on data stored in a primary database table in which the data is represented in the system default locale. The primary database table may be updated, modified, and maintained by the application component logic using JDBC.

Client components may generate method calls to the application component with input parameters represented in a plurality of locales. The localization logic may perform its translation functions operating on data stored in a localization table in which data is represented in locales corresponding to the locales in which client components may submit method calls. The localization table may include localization data corresponding to each of the client locales. The localization table may be updated, modified, and maintained by the localization logic using JDBC.

Each call from a client component to an application component may be intercepted. The call may be intercepted by a proxy for the application component. The proxy may determine if localization logic should be invoked in response to the intercepted call. If so, localization logic may be invoked. Thus, localization logic may be included after each intercepted call is received. Input parameters associated with the remote call may be translated from the locale of the call originator to the system default locale. The intercepted call may then be invoked as if the initial call had not been intercepted. After the invocation of the application component, additional localization logic may be executed to translate return values from the system default locale to the locale of the call originator. The results of invoking the initial call (translated return parameters) may be returned to the client component.

In one embodiment, the interception logic may also include a service locator. The service locator may be configured to return the client-side proxy to the client component in response to a call from the client component for a remote interface to the application component. The container-side proxy may be further configured to forward the remote calls to the application component. In one embodiment, the client component may execute on a Java Virtual Machine and the application component may execute on a different Java Virtual Machine than the client component. The component container may be an Enterprise JavaBeans component container and the application component may be developed as an Enterprise JavaBean.

The localization module including the localization logic may have knowledge of the system default locale, how to connect to the database using JDBC, the names of the primary and localization tables as well as the value object and entity fields along with which fields are required. All of this information may be stored in an XML metadata file descriptor, which may be loaded upon the startup of the server. In one embodiment, the concern-specific logic may be registered as a method invocation listener to receive remote method invocations for the application component.

### BRIEF DESCRIPTION OF THE DRAWINGS

FIG. 1 illustrates a three-tier architecture of a computer system, suitable for implementing various embodiments;

FIG. 2 illustrates one embodiment of interception logic configured to intercept calls to an application component and invoke concern-specific logic in response to an intercepted call;

FIG. 3 shows a flowchart of one embodiment of a method for intercepting calls to an application component and invoking concern-specific logic in response to an intercepted call to the application component;

FIG. 4 illustrates one embodiment of interception logic including a service locator, a client-side proxy and a container-side proxy;

FIG. 5 is a flowchart of one embodiment of a method for intercepting remote calls to an application component and invoking concern-specific logic in response to an intercepted remote call to the application component;

FIG. 6 illustrates exemplary primary and localization tables, according to one embodiment;

FIG. 7 illustrates components of an EJB component container involved in application component localization, according to one embodiment;

FIG. 8 is a flowchart of a method for localizing an application component, according to one embodiment;

FIG. 9 is a flow chart of a method of internationalizing an application component, according to one embodiment; and

FIG. 10 illustrates a computer system that may include one embodiment of interception logic configured to intercept calls to an application component and invoke interception and localization logic in response to an intercepted call to the application component.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

A major concern for global enterprise applications may be internationalization/localization. Localization may be the customization of data presentation of the set of political, cultural, and region-specific elements represented in an application. Each unique representation of the set of such elements may be referred to as a locale. For example, some of the elements included in such a localization set may be language, numerical representation, and units of measure such as date, time, temperature, currency, etc. An application that is not internationalized may have all information stored in one locale, which may be referred to as the system default locale. In order to internationalize such an application, business calls to application components may be intercepted. The parameters associated with the intercepted business calls may be translated by localization code from the locale of the caller to the system default locale without the need to modify the application component. Likewise the values returned by the application may be translated by localization code from the system default locale to the locale of the caller, again without the need to modify the application code. This may allow the internationalization of previously deployed applications with a minimum verification effort for the application logic.

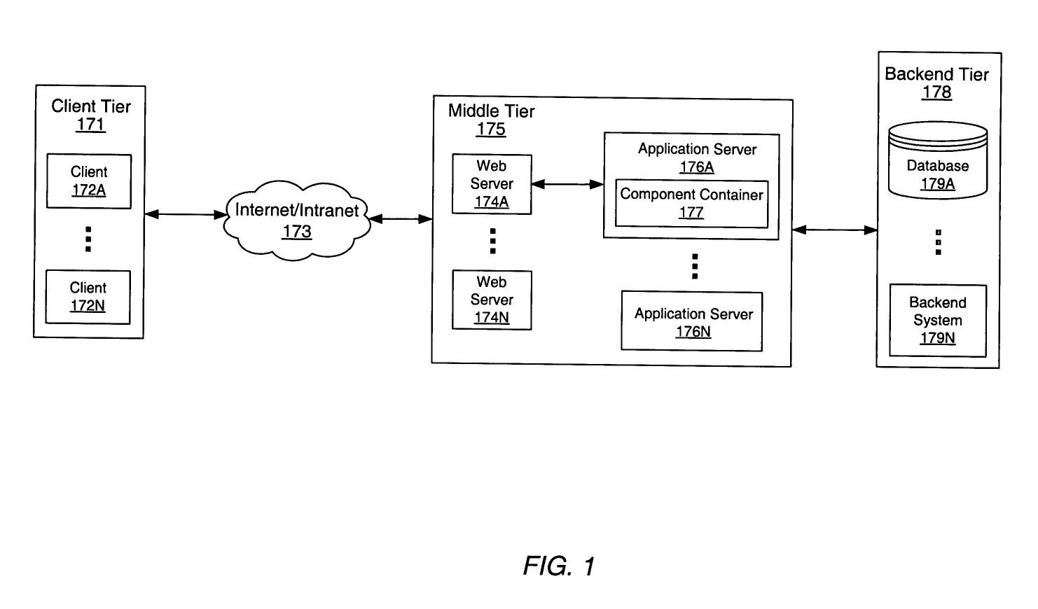

Suitable for implementing various embodiments of the disclosed invention, FIG. 1 illustrates a three-tier architecture of a computer system. The application logic of the computer system may be divided into application components (e.g., applets, servlets, server pages, beans, application clients, database objects) according to function and the various application components may be installed on different computers depending on factors such as security and load distribution. Tiers (e.g., client tier 171, middle tier 175, backend tier 178) may represent the logical or physical organization of the application components, which may operate across one or more different computers. The different computers may be based on different platforms and architectures. In one embodiment, the application components of the computer system may be based on a three-tier architecture. In other embodiments, the application components of the computer system may be based on a two-tier or N-tier architecture. Thus, the application components of a computer system based on the three-tier architecture of FIG. 1 illustrate only one example of a computer system suitable for implementing various embodiments of the disclosed invention.

Client tier 171 may include a number of different clients 172A through 172N (e.g., device, system, user interface) communicating to application components (e.g., servlets, server pages, beans) in the middle tier 175 via the Internet and/or an intranet 173. The middle tier 175 may include a number of different Web servers 174A through 174N and/or application servers 176A through 176N. In some embodiments, an application server 176 may include functionality typically provided by a Web server 174. For example, functionality provided by a Web server 174 may be included in an application server 176 eliminating the need for the Web server 174. The backend tier 178 may include a number of different computer systems such as database 179A through backend system 179N.

Application components may communicate using different types of protocols such as Hyper Text Transfer Protocol Secure sockets (HTTPS), Java™ Database Connectivity (JDBC), Java Naming and Database Interface (JNDI), and/or Simple Object Access Protocol (SOAP). The application components within a tier typically communicate with remote application components in an adjacent tier. For example, multiple users with access to an application component configured to operate in a client tier 171 (e.g., application client accessible via a Web browser) may initiate requests (e.g., application program call) to each remote application component configured to operate in a middle tier 175. Each application component in the middle tier 175 may, in turn, initiate requests to the backend tier 178 on behalf of the application component in the client tier 171. For example, an application component in the middle tier 175 (e.g., bean) may receive a remote request from a Web browser operating in the client tier 171 and in response access an application component (e.g., database object) operating in the backend tier 178. The application component in the backend tier 178 may then provide a response to the application component in middle tier 175 which may complete the remote request.

Some of the application components operating within the middle tier 175 may be configured to run within a component container 177 provided with an application server 176A. Some standard services (e.g., security, transaction management, state management, multi-threading) may be built into a platform and provided automatically to the application components via the container 177 and/or application server 176A. The component container 177, for example, may be configured to provide concern-specific logic for some standard services to application components running within the component container 177. For example, component containers 177 may provide application programming interfaces for some common services that application components use to access the services.

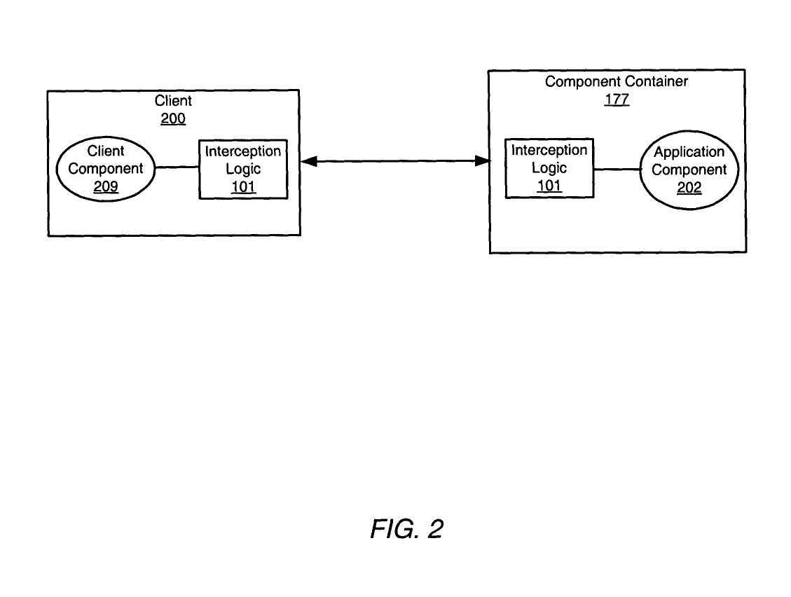

Some concern-specific logic may not be provided by the component container 177, but may be provided for by interception logic, as discussed herein. For example, internationalization and/or localization of an application may be facilitated by interception logic. FIG. 2 illustrates one embodiment of interception logic 101 configured to intercept calls to an application component 202 and invoke concern-specific logic in response to an intercepted call to the application component 202. Additional concern-specific logic, such as concern-specific logic not supported as a standard by a component container 177, may be provided and accessed through interception logic 101. For example, concern-specific logic accessible through interception logic 101 and separate from an application component 202 may provide to the application component 202 one or more services not provided as a standard service of the component container 177. Logic for localizing an application component is an example of such concern-specific logic that may be provided separately from the application component.

Interception logic 101 may be configured to intercept each remote call from a client component 209 to an application component 202. In response to the intercepted remote call to the application component 202, interception logic 101 may invoke localization logic on the container-side. Localization logic may translate input parameters associated with the remote call from the client locale to the system default locale. The intercepted remote call to the application component 202 may then be made to the application component 202. Localization logic may translate return values generated by the application component from the system default locale to the client locale. The translated results of the remote call invocation may then be returned to the client component 209. Note that a local method call may be localized in the same fashion as described for a remote call.

As described with FIG. 1, calls may be initiated from one or more application components (e.g., a client component 209) to one or more remote (or local) application components 202. A client component 209 may be any client of a computer system that initiates requests to an application component 202 and receives responses to the requests. For example, a client component 209 may be a dynamic Web page that relies on a Web server that generates Web pages using standard services provided by an application server. A client component 209 may include a Web browser (e.g., Internet Explorer or Netscape Navigator) that displays Web pages received from a Web and/or application server. In one embodiment, the client component 209 may be a dynamic Web page component developed with Java Server Pages or ASP.NET™ in a Web server such as Apache, Sun Open Net Environment (ONE) Application Server™ or Microsoft Internet Information Server (IIS)™, or any session component that is aware of the locale of the user.

In one embodiment, the application component 202 whose remote calls may be intercepted may be a bean such as an Enterprise JavaBeans™ (EJB™) and the bean may run within the component container 177. The application component 202 and/or localization logic may be developed using various frameworks such as Java™ 2 Platform, Enterprise Edition (J2EE™) from Sun Microsystems, Core Services Framework (CSP) from Hewlett Packard, Sun™ ONE Framework from Sun Microsystems, .NET Framework from Microsoft or some other framework. An integrated development environment (e.g., Microsoft Visual Studio .NET, open source NetBeans, Sun™ ONE Studio) may be used to automatically generate some or all of the application component 202 and/or localization logic.

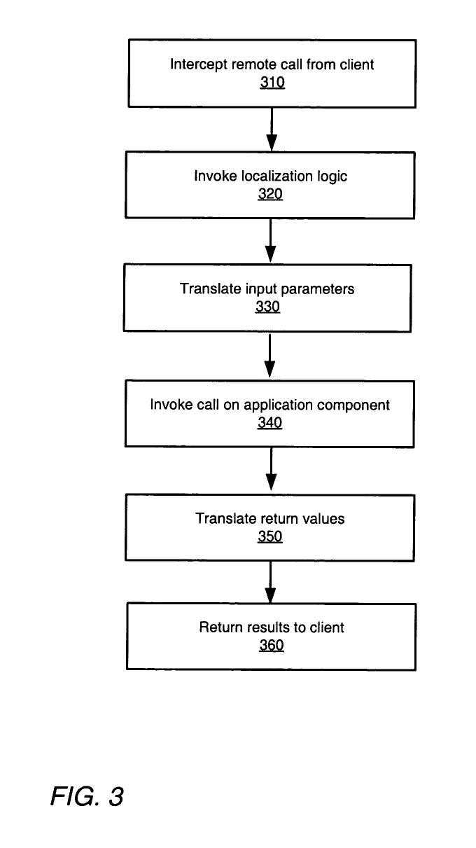

FIG. 3 shows a flowchart of one embodiment of a method for intercepting calls to an application component and invoking localization logic in response to an intercepted call to the application component. Each call from a client component to an application component for which interception logic has been provided may be intercepted, as indicated in 310. The remote call may be intercepted by a proxy for the application component. The proxy may determine if localization logic should be invoked in response to the intercepted call. If so, localization logic may be invoked. Thus, localization logic may be included after each intercepted remote call is received, as indicated in 320. Input parameters associated with the remote call may be translated from the locale of the call originator to the system default locale, as shown at 330. The intercepted remote call may then be invoked on the application component as if the initial remote call had not been intercepted, as indicated in 340. The application component will receive input parameters, perform necessary operations, and return values all in the system default locale and, therefore, the interception and locale translation is completely transparent to the application component. After the invocation of the application component, additional localization logic may be executed to translate return values from the system default locale to the locale of the call originator, as shown in block 350. At 360, the results of invoking the initial remote call (translated return parameters) may be returned to the client component.

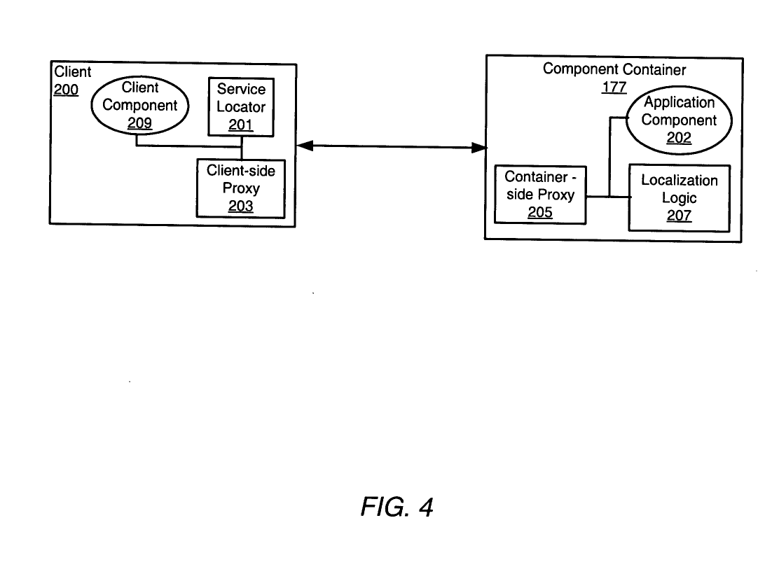

FIG. 4 illustrates one embodiment of interception logic including a service locator 201, a client-side proxy 203 and a container-side proxy 205. The service locator 201 may be configured to locate a remote interface of the application component 202 for use by a client to remotely access the application component. In response to a request from a client component 209, the service locator 201 may return a client-side proxy 203 that includes a remote interface to access the application component 202. The client-side proxy 203 may be configured to receive remote calls made by client component 209 to the application component 202. The client-side proxy 203 may forward the remote call to container-side proxy 205. Thus, container-side proxy 205 may “intercept” the remote call when it receives the remote call from the client-side proxy, in one embodiment. The container-side proxy 205 may determine whether or not to invoke localization logic 207 in response to the remote call. For example, if the call includes input parameters related to localizable data such as language, numerical representation, and units of measure such as date, time, temperature, currency, etc. then proxy 205 may invoke localization logic 207. The container-side proxy 205 may forward the remote call to the application component 202 for performance of the remote call. Post execution localization may be applied to any results, and the translated results may be returned to the client.

In one embodiment, to provide a container-independent approach, the service locator 201 may be configured separately from the component container 177. The service locator 201 may also be implemented as part of the component container 177 in other embodiments.

In one embodiment, implemented based on a service locator pattern, the service locator 201 may be configured to locate the remote interface of the application component 202 in response to an initial remote call from the client component 209 to the service locator 201. In other embodiments, the service locator may be implemented as part of a naming and directory service. The service locator returns a client-side proxy 203 to the client component 209. In one embodiment, the client-side proxy 203 may be configured from a class, instantiated on the client-side and configured to maintain a remote reference to the application component 202. The client-side proxy 203 may implement a remote interface of the application component 202 and forward remote calls to the container-side.

The service locator 201 may be configured to locate the remote interface instead of the client component 209 directly locating the remote interface from a directory and naming service. By having the client make requests for access to application components through the service locator, a client-side proxy may be returned that includes a remote interface to the requested application component. Returning a client-side proxy instead of just the remote interface allows remote calls to be “intercepted” for localization logic.

In one embodiment, the client-side proxy 203 may maintain a separate proxy object for providing access to business application methods of the application component 202. For example, the client-side proxy 203 may intercept each instantiation method (e.g., a create method) of an application component 202 and create a separate proxy object to implement the corresponding business application methods. In one embodiment, the client-side proxy 203 may be implemented using the java.lang.reflect.Proxy class of the Java Development Kit (JDK) from Sun Microsystems, Inc. The client-side proxy 203 may also be configured to do more than forward remote calls to the container-side. For example, in one embodiment, the client-side proxy 203 may be configured to locally cache state information for the application component 202 to avoid network overhead on each method call.

In one embodiment, the interception logic 101 may be configured to create a container-side proxy 205. For example, when the client-side proxy 203 intercepts an instantiation method (e.g., a create method) of an application component 202, the container-side proxy 205 may be instantiated in the component container 177. In one embodiment, the container-side proxy 205 may be configured from a class, instantiated on the container-side and configured to maintain a container-side remote reference to the application component 202. This instance of the container-side proxy 205 may be cached, and a reference to the container-side proxy 205 generated and returned to the client-side proxy 203. The container-side proxy remote reference to the application component 202 may be stored and maintained by the client-side proxy 203. The container-side proxy 205 may be configured to invoke localization logic included on the container-side 177. In one embodiment, the container-side proxy 205 may be implemented using a single stateless (or stateful) session bean.

The client-side proxy 203 may intercept each remote call to the application component 202 that originates from the client component 209. In one embodiment, requests from client component 209 may be forwarded from client-side proxy 203 to container-side proxy 205 using a serializable “method call” object, including information on the application component 202 being accessed, request type (e.g. method name) and request parameters. In one embodiment, the container-side proxy 205 may be configured to determine if localization logic should be invoked. The container-side proxy 205 may then invoke the container-side localization logic 207. Thus, instead of configuring each application component 202 of a computer system to include the localization logic 207, the localization logic 207 may be implemented as separate common concern logic and invoked in response to intercepted remote calls. Client-side and/or container-side proxies may be established for a plurality of client and application components to provide access to the common client-side or container-side localization logic without having to include the localization logic in each client or application component. In some embodiments, the client or application components may not even be aware of the proxies and/or localization logic. The application component may be designed for only a single locale, e.g. the system default locale. By the inclusion of interception and localization logic separate from the logic of the application component, the application component may be transparently internationalized to support different locales and/or regions without modifying the application component logic.

After invoking localization logic 207, the container-side proxy 205 may invoke the remote call to the application component 202. Localization logic 207 may receive values returned by the application component in response to the call and translate these values from the system default locale to the locale of the client requester. The localized results may be forwarded to the client component 209. Appropriate exceptions may be generated that may prevent the remote call from being invoked. In one embodiment, the result of the call to application component 202 may be forwarded from container-side proxy 205 to client-side proxy 203 using a serializable “method result” object, including information on the method result and exception thrown, if any.

In one embodiment, localization logic component 207 may be registered in an application server as a method invocation listener. For example, when a method invocation is received by container-side proxy 205 for application component 202, prior to forwarding the method invocation to the application component, it may be sent to localization logic component 207. Thus, localization logic may be provided for multiple application components without the client or application server container being aware of the interception logic (e.g. proxy framework) and localization logic.

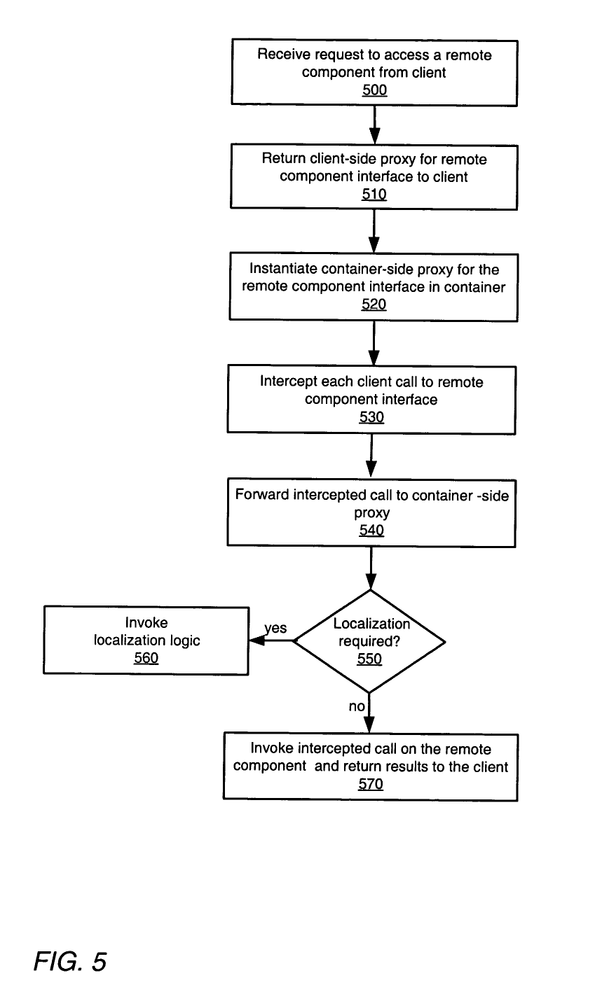

FIG. 5 shows a flowchart of one embodiment of a method for intercepting remote calls to an application component and invoking localization logic in response to an intercepted remote call to the application component. The localization logic may be configured to provide a service that is not included as a standard service of a component container. The localization logic and the application component may be configured to run within a component container. The following method is exemplary. Other variations may be performed by various embodiments of methods for intercepting remote calls to an application component and invoking localization logic in response to an intercepted remote call to the application component.

In one embodiment, a service locator may receive a call from a client component to access a remote application component, as indicated in 500. In one embodiment, instead of a client component directly locating a remote interface to the application component, the client calls the service locator to locate the remote interface. For example, in response to a remote call from a client component for access to the application component, the service locator may locate a remote interface of the application component. A client-side proxy that implements the application component remote home interface may then be instantiated and returned to the client component, as indicated in 510. The client-side proxy may appear to the client as the actual remote home interface. Thus, subsequent remote calls to the application component may then be received by the client-side proxy.

In one embodiment, a container-side proxy may be created. For example, when the client-side proxy intercepts an instantiation method (e.g., a create method) of an application component, the container-side proxy may be instantiated by the component container, as indicated in 520. The container-side remote reference to the application component may be stored and maintained by the container-side proxy. Localization logic included on the container-side may be invoked from the container-side proxy.

Each call to the application component, which originates from the client component may be received by the client-side proxy, as indicated in 530. The intercepted remote call may then be forwarded to the container-side proxy, as indicated in 540. In one embodiment, the container-side proxy may determine if localization logic has been included on the container-side and should be invoked or the container-side localization logic may be a listener for remote calls received at the container-side proxy, as indicated in 550. The container-side localization logic may then be invoked on the container-side, as indicated in 560. Thus, localization logic may be invoked on the container-side when each remote call is received by the container-side proxy. At decision block 575, the call may be examined to determine whether localization is required prior to the execution of the application component method. For example, the call may include input parameters that need to be translated into the system default locale before processing. If necessary, pre-execution localization logic may be invoked as shown at 580.

After invoking localization logic on the container-side, the remote call may be invoked as if the original remote call was not intercepted, as indicated in 570. At decision block 585 the results of the execution of the method call may be examined to determine whether post-execution localization is required. For example, execution of the method call may result in the generation of one or more return values, which are localizable. If required, post-execution localization may be performed, as shown at block 590. Results of the method invocation in the appropriate locale may then be forwarded to the client component, as indicated in block 595. Appropriate exceptions may be generated that may prevent the original remote call from being invoked. In one embodiment, exceptions may be propagated normally through the proxies such that the client-side proxy receives a remote exception wrapping the actual exception. In another embodiment, the exception may be captured by the container-side proxy and returned as a part of the results to the client component. The client-side proxy may then “re-throw” the actual exception to the client. In this embodiment, other information may also be returned in the results with the exception. For example, a container-side proxy reference for a call that resulted in an exception may be returned with the exception to the client.

As stated previously, an application that is not internationalized may have all information represented in one locale, which may be referred to as the system default locale. In order to internationalize the application, the service locator module returns dynamic proxies to intercept remote and local business calls. Each component in the application may have a corresponding database table where the system default locale information may be stored and which may be referred to as the primary table. Each localizable (translatable) entity may additionally be associated with one or more localization tables in which each locale translation, applicable to the given entity, may reside.

The presence of the elements needed for internationalization may not impact any primary table thus minimizing the impact of internationalization on existing applications. Since internationalization may only require the addition of new (localization) tables without modifications to existing tables, the main logic of an application may be virtually unaffected. Localization table entries may include the following information: a locale ID specifying the locale to which a particular entry corresponds, an object ID which may be used as the foreign key to the corresponding primary table and may show the primary key of an entity to which this translation should be applied, and all entity bean localizable fields. The primary key for this table may include the locale ID and object ID fields.

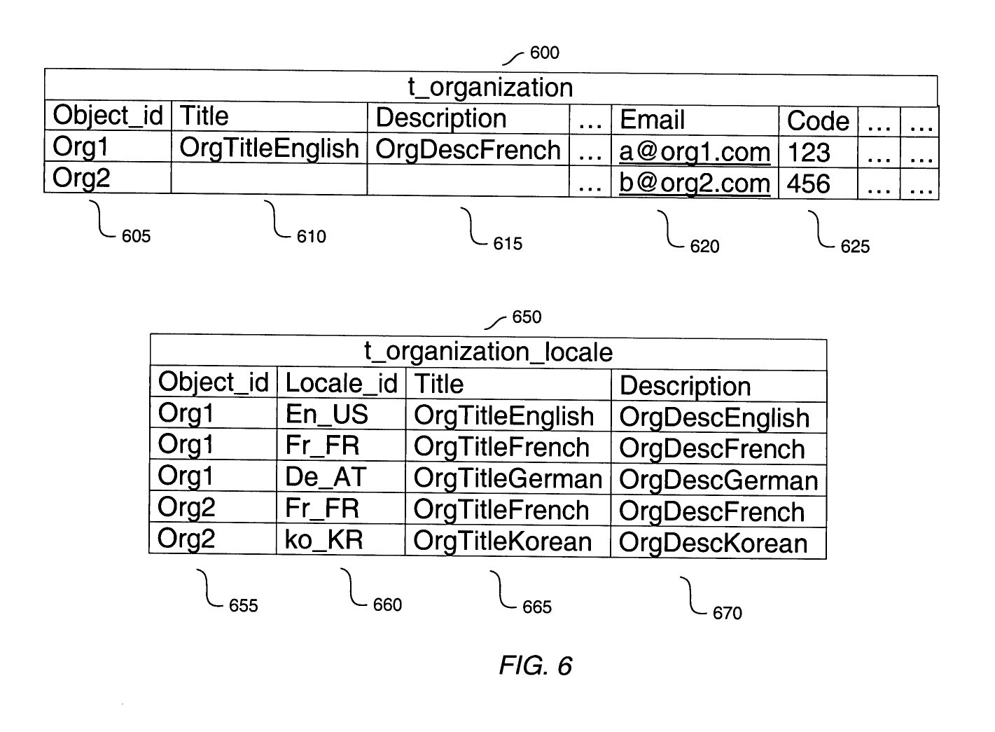

FIG. 6 illustrates exemplary primary and localization tables, according to one embodiment. An application component called Organization may be mapped to a primary table called t_organization 600. All information in the primary table t_organization 600 may be stored in the system default locale. Application component Organization and the corresponding session component may process information only in the system default locale. These aspects of the environment may be the same as if the application were not internationalized.

The localizable entity Organization may be associated with primary table t_organization 600. Primary table t_organization 600 may include two localizable fields: title 610 and description 615. The internationalization of Organization may include the addition of localization table t_organization_locale 650, which includes the sets of translations corresponding to each instance of organization. The system default locale_id may be en_US. Note that an organization with an object id 615 of org2 has empty fields for title and description since the entry may not be in the default locale. Also note that some information may be duplicated in the two tables.

The primary key of t_organization 600 may be object_id while the primary key of t_organization_locale 650 may be composed of object_id 655 and locale_id 660. Object_id 655 from t_organization_locale 650 may be a foreign key into object_id 605 of t_organization 600. Note that the primary table of Organization may be unaffected by this method of internationalization.

Other embodiments of methods for internationalization of applications may require the alteration of primary tables. In one embodiment, title 610 and description 615 may be removed from primary table 600. In another embodiment, an additional column referred to as locale_id may be included in primary table 600. In this case locale_id may indicate whether a given row in the primary table is in the default locale. If a row is in the default locale, there may be no need to use the localization table as it is clear that the information included in this entry is valid. For the primary table t_organization 600, the locale_id column would indicate that the org1 entry is in the default locale, while the org2 entry is not. Therefore, obtaining the organization “org1” would only require accessing the primary table 600, while obtaining the organization “org2” would require accessing the localization table 650.

The EJB Proxy Module may include a proxy listener (the class implementing java.lang.reflect.InvocationHandler) associated with each proxy returned by the service locator. The InvocationHandler's invoke( . . . ) may be called on any entity bean business method invocation. The proxy listener may include two sets of registered listeners, which may be referred to as pre-invocation listeners and post-invocation listeners. When the invoke( . . . ) method is called on the proxy listener, each registered pre-invocation listener may be notified and may take some action, the actual called entity bean method may be executed, and each registered post-invocation listener may be notified and take some action.

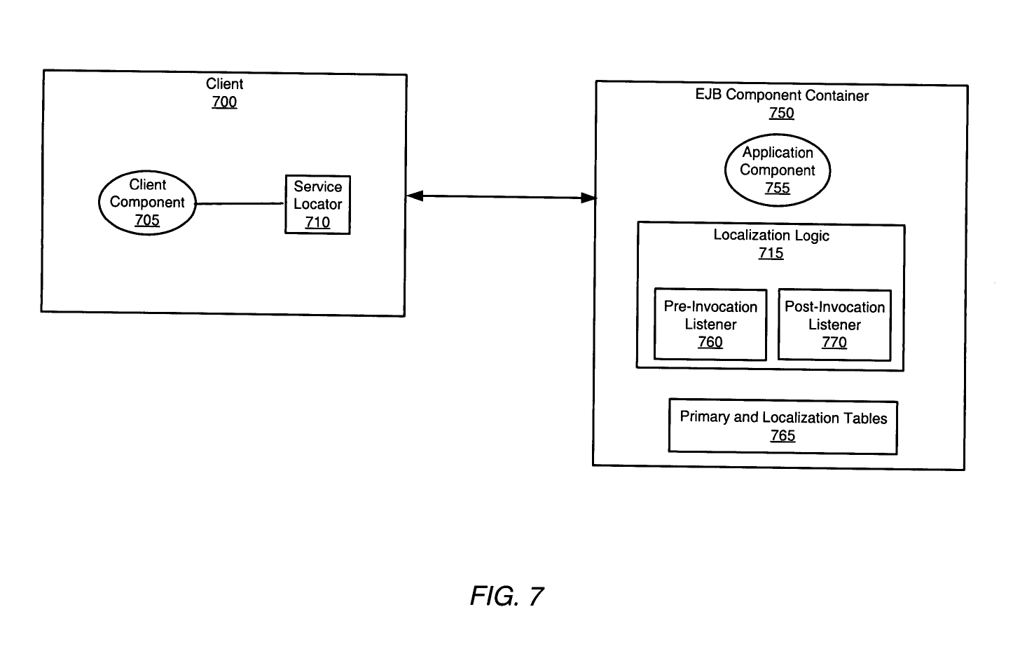

In the embodiment illustrated in FIG. 7, the proxy listener 705 may include PreInvocationListener 760 and PreInvocationListener 770 and may act as a translation interface between a locale-aware client (e.g. a session bean including localized information) and locale-independent entity beans such as application component 755 and EJB component container 750. The proxy listener 705 may register the two listeners referred to as PreInvocationListener 760 and PreInvocationListener 770 with the EJB Proxy Module. When any method is called on the entity bean's remote or local interface, PreInvocationListener 760 may be notified before the execution of the method, while PostInvocationListener 770 may be notified after the execution of the method.

Upon notification of a method call, localization logic 715 may determine the locale of the caller. If the locale of the caller is the system default locale, localization logic 715 may invoke application component 755. Application component 755 may perform its function using information from and updating the primary table 765, and return results to the caller. If the locale of the caller is other than the system default locale, localization logic may translate input parameters associated with the method call from the locale of the caller to the system default locale using information included in the appropriate localization table 775. In response to method calls requiring the update or modification of the data table, localization logic 715 may maintain localization tables 775 while the application component 755 may perform necessary modifications to the primary table. For method calls not in the system default locale, localization logic 715 may intercept return values produced by the invocation of the application component and translate them from the system default locale to the locale of the caller and then return the translated values to the calling entity.

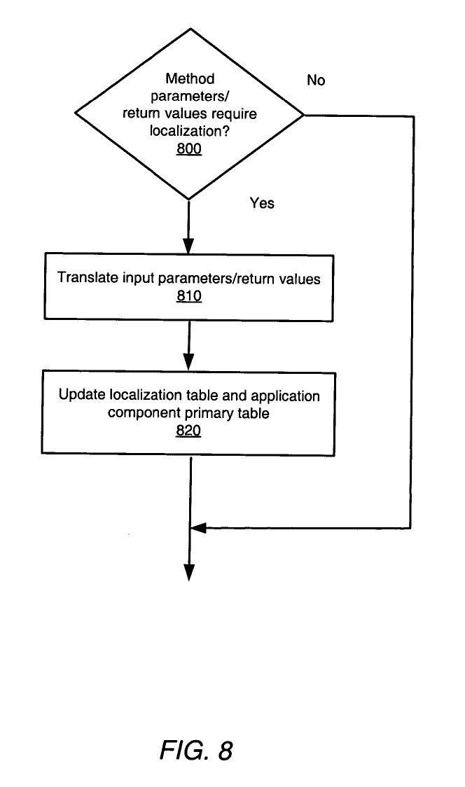

As shown in the flowchart of FIG. 8, if either PreInvocationListener or PostInvocationListener are notified, they may check to determine whether the called method is related to localization as shown at block 800. If the method requires or returns localizable parameters, the dynamic proxies may invoke the appropriate localization logic to perform the required translations as indicated in 810. For example, if the native locale for the application is United States and a client in Germany is attempting to get a price for an item, the PreInvocationListener proxy may initiate localization logic to convert the item description from German to English. This parameter translation may be accomplished by means of Java Reflection in some instances.

The application component Bean may use the translated descriptive information to retrieve the price of the item in dollars. The PostInvocationListener may recognize that a conversion of the output parameter is required and initiate further localization logic to translate the price of the item from dollars to euros before returning the value to the client. As illustrated in block 820, the localization logic may maintain the localization table while the primary table may be maintained through the initial entity bean.

For example, an entity EJB named Organization may be provided in several locales. Organization may include several methods as follows. The method public OrganizationValueObject getValueObject( ) may be intercepted by the PostInvocationListener. The entity bean may return information in the system default locale. If the current session requires the information to be in a different locale, localization logic may translate the return value using data from the localization table and applying JDBC and/or Java Reflection.

The method The method public void update(OrganizationValueObject obj) may be intercepted by the PreInvocationListener. If obj is not in the system default locale, localization logic may insure that localizable fields in the primary table are not updated by modifying obj. The localization logic may also update the localization table using JDBC.

The method The method public void create(ComputerDescriptionValueObject obj) may be intercepted by the PreInvocationListener. If obj is not in the system default locale, localizable fields may be set to null through Java Reflection since the primary table never stores information, which is not in the system default locale. The localization logic may use the input parameters to create a record in the localization table using JDBC.

The method public void remove may be intercepted by the PostInvocationListener. The localization logic may remove all information referring to the entity from the localization table.

The localization module including the localization logic may have knowledge of the system default locale, how to connect to the database using JDBC, the names of the primary and localization tables as well as the value object and entity fields along with which fields are required. All of this information may be stored in an XML metadata file descriptor, which may be loaded upon the startup of the server.

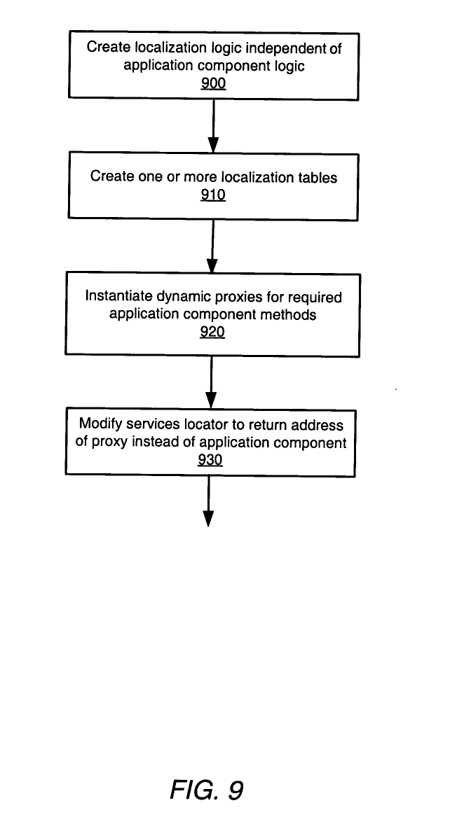

FIG. 9 is a flow chart of a method of internationalizing an application component, according to one embodiment. For a non-internationalized application that has been widely deployed, a method of internationalization that impacts the application component logic either not at all, or to the least extent possible may be desirable. As shown at 900, localization logic may be created that provides for the conversion and/or translation of localizable parameters completely independently of the application component logic. Block 910 indicates that localization tables may be created to store values of all localizable parameters and return values for each needed locale. For example, an application whose system default locale is United States, English may need to be deployed in Switzerland. Switzerland may have four national languages and it may be desirable to support at least German and French localizations. German and French localization tables may be created to store localized forms of messages, units of measure, and other information used by the application.

As indicated at block 920, dynamic proxies may be instantiated for each method associated with the application component that may include parameters requiring localization. A dynamic proxy may include a pre-invocation listener that is notified of the application component method call before the method is executed. The pre-invocation listener may determine whether any of the input parameters associated with the method need to be localized, and if so, may invoke localization logic to perform the needed translation. The dynamic proxy may also include a post-invocation listener proxy, which may be instantiated to be notified upon the completion of execution of the application component. The post-invocation listener may determine whether any of the return values associated with the method need to be localized, and if so, may invoke localization logic to perform the needed translation. The service locator may need to be modified so that it returns that address of the proxy corresponding to the application component, as indicated at block 930.

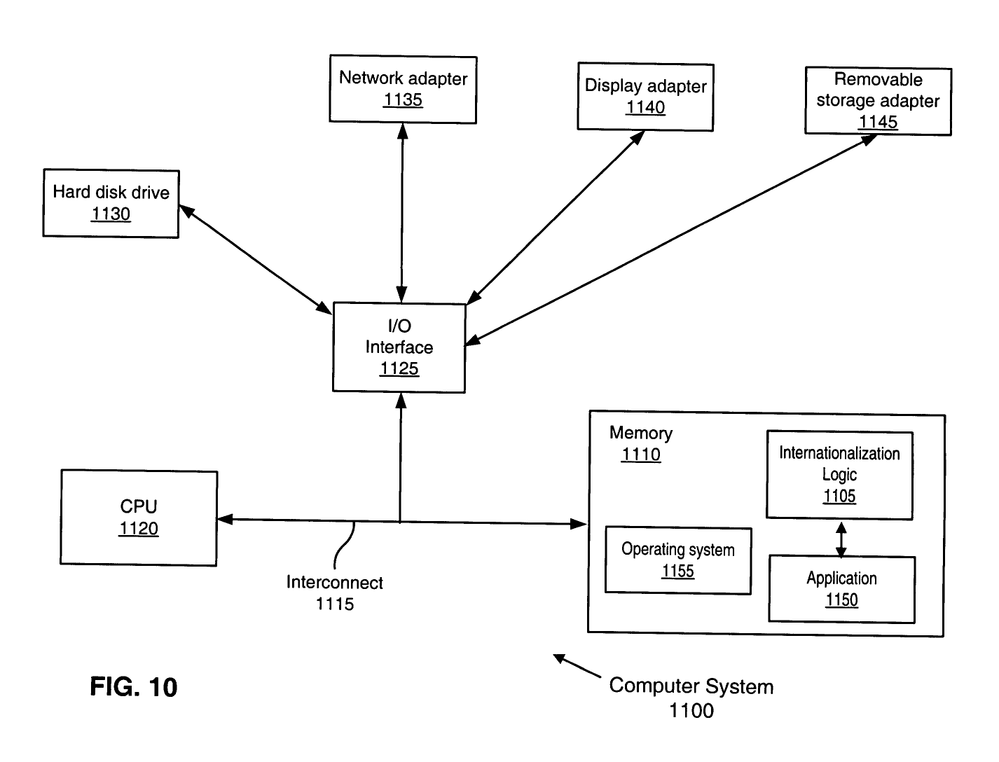

FIG. 10 illustrates one embodiment of a computer system 1100 that may include interception and localization logic 1105. Computer system 1100 may include many different components such as memory 1110, a central processing unit (CPU) or processor 1120, and an input/output (I/O) interface 1125. Interconnect 1115 is relied upon to communicate data from one component to another. For example, interconnect 1115 may be a point-to-point interconnect, a shared bus, a combination of point-to-point interconnects and one or more buses, and/or a bus hierarchy including a system bus, CPU bus, memory bus and I/O buses such as a peripheral component interconnect (PCI) bus.

The computer system 1100 preferably includes a memory medium on which computer programs according to various embodiments may be stored. The term “memory medium may include an installation medium, e.g., a CD-ROM, or floppy disk; a computer system memory such as DRAM, SRAM, EDO DRAM, SDRAM, DDR SDRAM, Rambus RAM, etc., or a non-volatile memory such as a magnetic media, e.g., a hard drive 1130, or optical storage. The memory medium may include other types of memory as well, or combinations thereof. In addition, the memory medium may be located in a first computer in which the programs are executed, or may be located in a second different computer, which connects to the first computer over a network. In the latter instance, the second computer provides the program instructions to the first computer for execution.

Also, the computer system 1100 may take various forms, including a personal computer system, mainframe computer system, workstation, network appliance, Internet appliance, personal digital assistant (PDA), television system or other device. In general, the term “computer system” can be broadly defined to encompass any device having a processor, which executes instructions from a memory medium. The memory medium preferably stores a software program or programs for event-triggered transaction processing as described herein. The software program(s) may be implemented in any of various ways, including procedure-based techniques, component-based techniques, and/or object-oriented techniques, among others. For example, the software program may be implemented using ActiveX controls, C++ objects, JavaBeans, Microsoft Foundation Classes (MFC), or other technologies or methodologies, as desired.

Memory 1110 may store program instructions accessed by the CPU 1120. For example, one or more applications 1150, interception and localization logic 1105 as described herein, and an operating system 1155 may be stored in memory 1110.

Computer system 1100 may further include other software and hardware components, such as an input/output (I/O) interface 1125, that may be coupled to various other components and memory 1110. The CPU 1120 may acquire instructions and/or data through the I/O interface 1125. Through the I/O interface 1125, the CPU 1120 may also be coupled to one or more I/O components. As illustrated, I/O components may include a hard disk drive 1130, a network adapter 1135, a display adapter 1140 and/or a removable storage adapter 1145. Some components 1130 to 1145 may be coupled to the I/O interface 1125. In addition, the computer system 1100 may include one or more of a particular type of component. The computer system 1100 may include one or more components coupled to the system through a component other than the I/O interface 1125. Some computer systems may include additional and/or other components such as application software (e.g., stored in memory 1110), other CPUs, video monitors or other displays, track balls, mice, keyboards, printers, plotters, scanners, or other types of I/O devices for use with computer system 1100.

In one embodiment, interception and localization logic 1105 may be configured within an application server. The application server may provide system-level services to application components that operate across different computers based on different platforms and architectures. According to one embodiment, the application components may be implemented on virtual machines (VMs) (e.g., Java Virtual Machines) coupled to interception and localization logic 1105. In one embodiment, the client-side application components may be implemented on virtual machines (VMs) (e.g., Java Virtual Machines). The virtual machines may be implemented on one or more computers 1100. Interception and localization logic 1105 may operate on different and various types of computers that may communicate to each other over a network. For example, a client may operate on a desktop computer running Windows™ NT from Microsoft and an application server, in one embodiment, may operate on a minicomputer running an operating system such as Sun™ Linux from Sun Microsystems.

The flow charts described herein represent exemplary embodiments of methods. The methods may be implemented in software, hardware, or a combination thereof. The order of method may be changed, and various elements may be added, reordered, combined, omitted, modified, etc.

Various modifications and changes may be made to the invention as would be obvious to a person skilled in the art having the benefit of this disclosure. It is intended that the following claims be interpreted to embrace all such modifications and changes and, accordingly, the specifications and drawings are to be regarded in an illustrative rather than a restrictive sense.

Various embodiments may further include receiving, sending or storing instructions and/or data implemented in accordance with the foregoing description upon a computer readable medium. Generally speaking, a computer readable medium may include storage media or memory media such as magnetic or optical media, e.g., disk or CD-ROM, volatile or non-volatile media such as RAM (e.g. SDRAM, DDR SDRAM, RDRAM, SRAM, etc.), ROM, etc. as well as transmission media or signals such as electrical, electromagnetic, or digital signals, conveyed via a communication medium such as network and/or a wireless link.

1. A system, comprising:
an application server comprising:
an application component whose data is represented in a system default locale;
localization logic configured to translate input parameters or return values between the system default locale and another locale; and
interception logic configured to intercept a plurality of method calls to the application component;
wherein the interception logic is configured to invoke the localization logic and the application component in response to one or more of the plurality of method calls.

2. The system as recited in claim 1, wherein the localization logic is separate from the application component logic.

3. The system as recited in claim 1, wherein the application component logic is configured to operate on data stored in a primary database table in which the data is represented in the system default locale.

4. The system as recited in claim 3, wherein the application component logic is configured to invoke one or more Java Data Base Connectivity methods to maintain the primary database table.

5. The system as recited in claim 1, wherein the localization logic is configured to operate on data stored in one or more localization database tables in which the data is represented in a locale other than the system default locale.

6. The system as recited in claim 5, wherein the localization logic is configured to invoke one or more JDBC methods to maintain the one or more localization database tables.

7. The system as recited in claim 1, wherein the interception logic includes one or more dynamic proxies that are configured to intercept application component method calls before the execution of the method.

8. The system as recited in claim 1, wherein the localization logic is configured to make one or more Java reflection calls to determine whether input parameters to, or return values from the application component are localizable.

9. The system as recited in claim 1, wherein the localization logic is configured to invoke localization functions before and after the execution of the method.

10. The system as recited in claim 1, further comprising a metadata file indicating the system default locale and translatable table information for the application component.

11. A method, comprising:
creating a dynamic proxy for an application component comprising one or more localizable parameters or return values;
modifying a service locator to return an interface to the proxy;
storing one or more localization tables wherein each localization table stores localizable parameters or return values for a locale; and
the dynamic proxy invoking localization logic, separate from application logic, to translate localizable parameters or return values between a system default locale to another locale.

12. A method, comprising:
intercepting a method call to an application component before or after the execution of the method;
determining whether input parameters or return values associated with the method call are localizable;
localizing input parameters or return values based on data stored in one or more localization tables;
invoking the application component to execute the method;
maintaining a primary data table for the application component; and
maintaining the localization tables.

13. The method as recited in claim 12, wherein said intercepting comprises calling a dynamic proxy for the application component.

14. The method as recited in claim 12, wherein said determining comprises making one or more Java reflection calls to the application component.

15. The method as recited in claim 12, wherein said maintaining of the primary and localization tables comprises invoking one or more JDBC methods to access one or more databases.

16. The method as recited in claim 12, wherein said maintaining of the primary data table is performed by application component logic.

17. The method as recited in claim 16, wherein said maintaining of the localization tables is performed by localization logic separate from the application component logic.

18. The method as recited in claim 12, further comprising accessing from a metadata file information about the system default locale and translatable table information.

19. The method as recited in claim 12, wherein said intercepting is performed by logic that is separate from logic for executing the method.

20. A computer accessible medium comprising program instructions, wherein the program instructions are executable to:
create a dynamic proxy for an application component comprising localizable parameters or return values;
modify a service locator to return an interface to the proxy;
store one or more localization tables wherein each localization table stores localizable parameters or return values for a locale; and
implement localization logic, separate from application logic, invoked by the dynamic proxy to translate localizable parameters or return values between a system default locale to another locale.

21. A computer accessible medium comprising program instructions, wherein the program instructions are executable to:
intercept a method call to an application component before or after execution of the method;
determine whether input parameters or return values associated with the method call are localizable;
localize input parameters or return values based on data stored in one or more localization tables;
invoke the application component to execute the method;
maintain a primary data table for the application component; and
maintain the localization tables.

22. The computer accessible medium as recited in claim 21, wherein the program instructions are further executable to call dynamic proxies to intercept the method call to the application component before and after execution of the method.

23. The computer accessible medium as recited in claim 21, wherein the program instructions are further executable to make Java reflection calls to determine whether input parameters or return values associated with the method call are localizable.

24. The computer accessible medium as recited in claim 21, wherein the program instructions are further executable to invoke one or more JDBC methods to maintain primary and localization tables.

25. The computer accessible medium as recited in claim 21, wherein the program instructions of the application component logic are further executable to maintain the primary data table.

26. The computer accessible medium as recited in claim 21, wherein the program instructions of the localization logic are further executable to maintain the localization data tables.

27. The computer accessible medium as recited in claim 21, wherein information about the system default locale and translatable table information is stored in an XML metadata file.

28. The computer accessible medium as recited in claim 21, wherein said intercepting is performed by logic that is separate from logic for executing the method.
